(19) United States
(12) Patent Application Publication
(10) Pub. No.: US 2023/0394234 A1
(43) Pub. Date: Dec. 7, 2023

(54) SYSTEM AND METHOD FOR EXTERNAL VEHICLE MAPPING

(71) Applicants: Sam Hijazi, Austin, TX (US); Christopher Reynoso, Austin, TX (US); Ahmad El Solh, Austin, TX (US); Nilesh Patel, Glendale, CA (US)

(72) Inventors: Sam Hijazi, Austin, TX (US); Christopher Reynoso, Austin, TX (US); Ahmad El Solh, Austin, TX (US); Nilesh Patel, Glendale, CA (US)

(21) Appl. No.: 17/830,242

(22) Filed: Jun. 1, 2022

(51) Int. Cl. G06F 40/216; G07C 5/00

(52) U.S. Cl. CPC G06F 40/216; G07C 5/008

(57) ABSTRACT

Systems and methods for external vehicle mapping, including mapping processes, using natural language processing, machine learning processes, rule sets, and storage of information that is usable by external data targets.

### TECHNICAL FIELD

The embodiments disclosed herein generally relate to computer implemented systems and methods for external vehicle mapping.

### BACKGROUND

Automobile and other vehicle sales often occur at centralized locations called dealerships. Dealerships or car dealers, as they are known in the automobile industry, are merchants who specialize in the buying, selling, trading, and leasing of various types of vehicles. The stock or collection of vehicles sold at any particular dealership may include any of a wide array of new and/or used vehicle makes or manufactures (e.g. Dodge, Jeep, Oldsmobile, Toyota, Fiat, Chrysler, Mercedes, or many others).

Different manufacturers or car companies may stylize vehicle features, components, and accessory packages in different ways for sales and marketing purposes. For instance, one car company may offer air conditioned seats and call the feature a cooling package, while another company may offer the same feature and call it a ventilation package. As such, there is a lack of standardization across all automobile manufacturers and even among models of a single manufacturer.

While many major dealerships may sell new vehicles from a single manufacturer, used cars that are traded in and later resold by the dealership may not be from the same manufacturer as the new vehicle stock. This can create problems when dealerships want to have an accurate understanding of what vehicles they possess and what features they include. This information is often important in offering the used vehicles for sale, since customers may request or require particular features or packages. While window stickers, VIN numbers, or other identifying information can be used to identify specific vehicles, dealers may still not have total accuracy in their identification systems and online offerings. As such, the use of computer implemented systems and methods for mapping features to common standardized terms would be highly beneficial information for analysis and management in this context.

### SUMMARY OF THE INVENTION

This summary is provided to introduce a variety of concepts in a simplified form that is further disclosed in the detailed description of the embodiments. This summary is not intended for determining the scope of the claimed subject matter.

The system may generally rely on a defined set of data that is desired, required, and/or acceptable to at least one third-party remote system. For each vehicle to be sent or syndicated to the remote system(s), data that would previously have been sent as-is or in rough or raw data format, the systems and processes described herein can be run to replace such raw data with data in the desired format. Rule sets generated using machine learning and in some instances human analysis can be used to match the vehicles attributes (e.g. colors, transmission, engine, make model, trim, style, and others), as well as options and packages (e.g. premium package, heated seats, panoramic roof, and others), to match and substitute the equivalent representation as defined by the remote system.

The embodiments provided herein relate to external vehicle mapping inventory management and analysis. In general, these computer implemented systems and methods include the use of mapping of vehicle information by performing one or a series of operations on the vehicle information and building and enhancing an inventory management system for further use by the system and/or third parties.

Systems and methods implemented according to the teachings described herein can be used to determine the characteristics, features, components, options, and packages for various vehicles at dealerships. Organizing, storing, mapping, and using data related to vehicle information is eminently important and allows dealers to better understand their inventory. Such data can be stored in many formats and benefits from modern data processing operations, such as machine learning, natural language processing, and application of rule sets.

Thus, the systems and methods herein can be used to accurately capture information related to vehicles and determine precise term definitions for mapping of features for use by dealerships.

### BRIEF DESCRIPTION OF THE DRAWINGS

A complete understanding of the present embodiments and the advantages and features thereof will be more readily understood by reference to the following detailed description when considered in conjunction with the accompanying drawings wherein:

FIG. 1 illustrates a system architecture diagram of the network infrastructure, according to some embodiments;

FIG. 2 illustrates an external vehicle mapping process flowchart, according to some embodiments;

FIG. 3 illustrates code for adding VIN data to a system, according to some embodiments;

FIG. 4 illustrates an advertising site wireframe, according to some embodiments;

FIG. 5 illustrates data parsed into an inventory matching system wireframe, according to some embodiments; and

FIG. 6 illustrates a flow chart; according to some embodiments.

### DETAILED DESCRIPTION

Before describing example embodiments in detail, it is noted that the embodiments reside primarily in combinations of components and procedures related to the system. Accordingly, the system components have been represented where appropriate by conventional symbols in the drawings, showing only those specific details that are pertinent to understanding the embodiments of the present disclosure so as not to obscure the disclosure with details that will be readily apparent to those of ordinary skill in the art having the benefit of the description herein.

In general, the embodiments herein are implemented in system to system instances, although in some embodiments, other arrangements are possible.

Third parties such as non-traditional dealerships who primarily purchase and sell used cars may not understand or have institutional knowledge of various package or feature designations, which can evolve and change over time even for a single manufacturer. However, these third-parties may put together a standardized designation of the features they know customers are looking for, such as air-conditioned seats. In internal and client-facing communications they may use such designation across all types of used cars they receive and sell. In many instances it is beneficial for these third-parties to have a system for understanding various designations among different manufacturers over different years, models, and packages. The embodiments herein are useful in providing such external vehicle mapping.

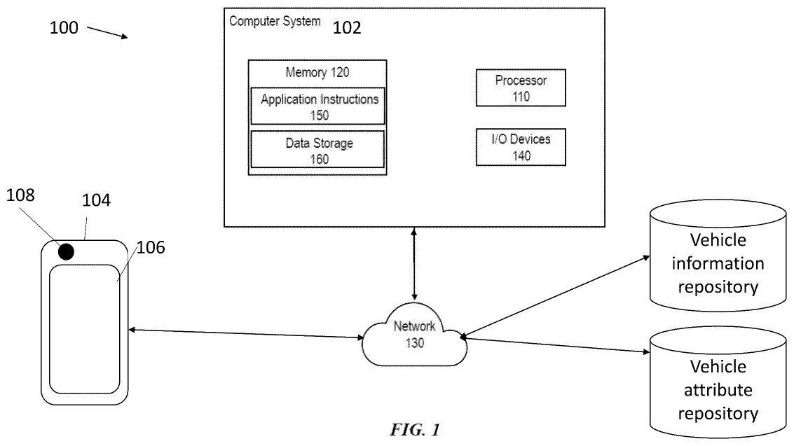

FIG. 1 illustrates a system architecture diagram 100, including a computer system 102, which can be utilized to provide and/or execute the processes described herein in various embodiments. The computer system 102 can be comprised of a standalone computer or mobile computing device, a mainframe computer system, a workstation, a network computer, a desktop computer, a laptop, a tablet, a smartphone, a videogame console, or the like. The computer system 102 includes one or more processors 110 coupled to a memory 120 via an input/output (I/O) interface. Computer system 102 may further include a network interface to communicate with the network 130. One or more input/output (I/O) devices 140, such as video device(s) (e.g., a camera), audio device(s), and display(s) are in operable communication with the computer system 102. In some embodiments, similar I/O devices 140 may be separate from computer system 102 and may interact with one or more nodes of the computer system 102 through a wired or wireless connection, such as over a network interface. In many embodiments, computer system 102 can be a server that is fully automated or partially automated and may operate with minimal or no interaction or human input during processes described herein. As such, many embodiments of the processes described herein can be fully automated or partially automated.

Processors 110 suitable for the execution of a computer program include both general and special purpose microprocessors and any one or more processors of any digital computing device. The processor 110 will receive instructions and data from a read-only memory or a random-access memory or both. The essential elements of a computing device are a processor for performing actions in accordance with instructions and one or more memory devices for storing instructions and data. Generally, a computing device will also include, or be operatively coupled to receive data from or transfer data to, or both, one or more mass storage devices for storing data, e.g., magnetic, magneto-optical disks, or optical disks; however, a computing device need not have such devices. Moreover, a computing device can be embedded in another device, e.g., a mobile telephone, a personal digital assistant (PDA), a mobile audio or video player, a game console, a Global Positioning System (GPS) receiver, or a portable storage device (e.g., a universal serial bus (USB) flash drive).

A network interface may be configured to allow data to be exchanged between the computer system 102 and other devices attached to a network 130, such as other computer systems, or between nodes of the computer system 102. In various embodiments, the network interface may support communication via wired or wireless general data networks, such as any suitable type of Ethernet network, for example, via telecommunications/telephony networks such as analog voice networks or digital fiber communications networks, via storage area networks such as Fiber Channel storage area networks (SANs), or via any other suitable type of network and/or protocol.

The memory 120 may include application instructions 150, configured to implement certain embodiments described herein, and at least one database or data storage 160, comprising various data accessible by the application instructions 150. In at least one embodiment, the application instructions 150 may include software elements corresponding to one or more of the various embodiments described herein. For example, application instructions 150 may be implemented in various embodiments using any desired programming language, scripting language, or combination of programming languages and/or scripting languages (e.g., C, C++, C#, JAVA®, JAVASCRIPT®, PERL®, etc.).

The steps and actions of the computer system 102 described in connection with the embodiments disclosed herein may be embodied directly in hardware, in a software module executed by a processor, or in a combination of the two. A software module may reside in random-access memory (RAM), flash memory, read-only memory (ROM) memory, erasable programmable read-only memory (EPROM) memory, electrically erasable programmable read-only memory (EEPROM) memory, registers, a hard disk, a solid-state drive (SSD), hybrid drive, dual-drive, a removable disk, a compact disc read-only memory (CD-ROM), digital versatile disc (DVD), high definition digital versatile disc (HD DVD), or any other form of non-transitory storage medium known in the art or later developed. An exemplary storage medium may be coupled to the processor 110 such that the processor 110 can read information from, and write information to, the storage medium. In the alternative, the storage medium may be integrated into the processor 110. Further, in some embodiments, the processor 110 and the storage medium may reside in an Application Specific Integrated Circuit (ASIC). In the alternative, the processor and the storage medium may reside as discrete components in a computing device. Additionally, in some embodiments, the events or actions of a method or algorithm may reside as one or any combination or set of codes and instructions on a machine-readable medium or computer-readable medium, which may be incorporated into a computer program product.

Also, any connection may be associated with a computer-readable medium. For example, if the software is transmitted from a website, server, or other remote source using a coaxial cable, fiber optic cable, twisted pair, digital subscriber line (DSL), or wireless technologies such as infrared, radio, Bluetooth, Wi-Fi, microwave, or others, then the coaxial cable, fiber optic cable, twisted pair, DSL, or wireless technologies such as infrared, radio, Bluetooth, Wi-Fi, microwave, or others can be included in the definition of medium. “Disk” and “disc,” as used herein, include compact disc (CD), laser disc, optical disc, digital versatile disc (DVD), floppy disk, and Blu-ray disc or others where disks usually reproduce data magnetically, while discs usually reproduce data optically with lasers. Combinations of the above should also be included within the scope of computer-readable media.

It should be understood by those in the art that computer system 102 also includes power components that are operably coupled such that the system is operable. This can include one or more batteries if computer system 102 is mobile.

In some embodiments, the system is world-wide-web (www) based, and the network server is a web server delivering HTML, XML, etc., web pages to the computing devices. In other embodiments, a client-server architecture may be implemented, in which a network server executes enterprise and custom software, exchanging data with custom client applications running on the computing device 102.

As shown in the example embodiment, a mobile computing device 104 can also be communicatively coupled with and exchange data with network 130. Those in the art will understand that mobile computing device 104 can include some or all of the same or similar components as computer system 102 coupled to constitute an operable device. Mobile computing device 104 can be a personal digital assistant (PDA), smartphone, tablet computer, laptop, wearable computing device such as a smartwatch or smart glasses, or other device that includes one or more user interface 106, such as a touchscreen and/or audio input/output and/or other display and user input components. Mobile computing device 104 can also include one or more image capturing or reading component 108 (e.g. a digital camera, scanner, or others) and associated structures and elements operatively coupled to at least one processor and memory of the mobile computing device. Such image capturing component 108 can be operable to capture an image of a label and/or code (e.g. a quick response (QR) code or others) automatically or upon one or more user input commands.

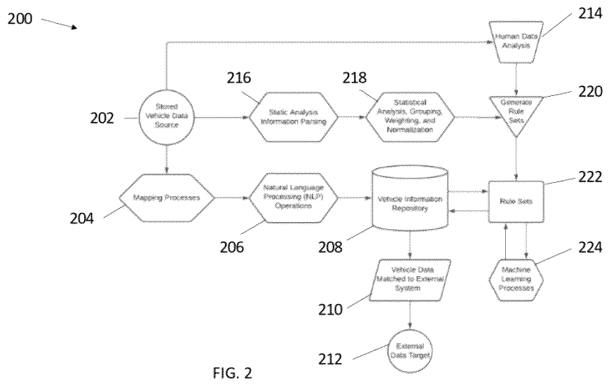

FIG. 2 illustrates a flowchart 200 of an external vehicle mapping process, according to some embodiments. In an example embodiment, stored vehicle data source 202 can include vehicle data as entered by dealership employees or others; gathered from or sent by manufacturers, dealers, automobile repair shops, aftermarket parts dealers and installers, and other databases; scanned from QR or other codes that may be located on window stickers or other locations; or others. Information in addition to characteristics, features, options, packages, and other data for vehicle data source 202 can include data such as make, model, color, accessories, recall history, Department of Motor Vehicle (DMV) information, and/or other information that may be individually associated with each vehicle. This information/data can be located in one or more locations such as non-transitory computer readable memory stored database(s) and may include information gathered from one or more locations, electronic databases and communications, or others. In some instances data stored in vehicle data source 202 can be purchased or subscribed to, or otherwise available for use by one or more parties.

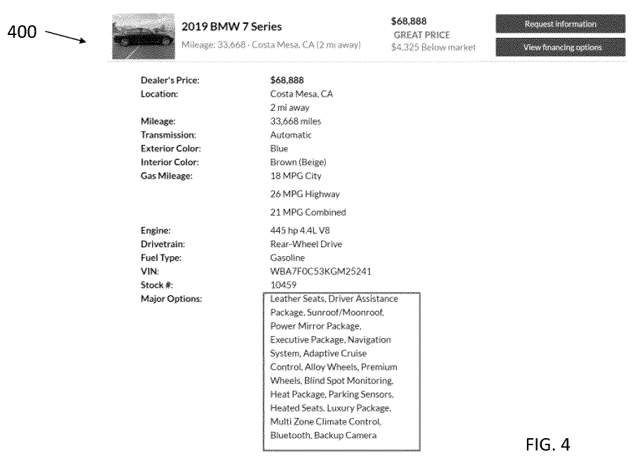

Data from a stored vehicle data source 202 can be sent to, pushed to, pulled from storage, or otherwise accessed and used by mapping processes 204. Mapping processes can include one or more steps or operations by which data is mapped to useful and/or logical locations. In some embodiments, mapping operations can include associating data about individual vehicle features and packages to a standardized template or index (see FIG. 4 and associated description for additional information). Such information can then be usable by the system and/or third-parties for a variety of useful operations.

Mapping processes 204 can be subjected to or run through natural language processing (NLP) operations 206. These natural language processing operations 206 can include using one or more models or trained interpretation operations to glean useful data and/or otherwise organize such data from an informal or non-standardized dataset into a formal and standardized organization scheme. For example, certain words, phrases, figures of speech, shorthand references, colloquialisms, or other informal language may be used to describe identical information in many different ways. Although a human may understand some, many, or all of the informal language used, the data can be better used by computing systems once it has organized it into a standardized format. As an example, a window on the roof of a vehicle that can be operably opened by a driver may be called a moonroof by some manufacturers, while some members of the general public may refer to it as a sunroof, which typically is opaque and does not refer to the exact same feature. Similarly, humans might refer to a feature in a single manner, while individual manufacturers may refer to the feature in many different manners. Machine learning, artificial intelligence, and/or physical updates by a human system user can all be used to organize data in various embodiments, and standardize the data for storage and use by the system.

Results from NLP operations 206 can be stored in vehicle information repository 208. Vehicle information repository 208 can be one or more databases stored in non-transitory computer readable memory on a server or other computing device that is locally accessible or remotely accessible via a network by computing devices. Data can be stored in any number of useful logical formats. Vehicle information repository 208 is typically part of the system in many embodiments.

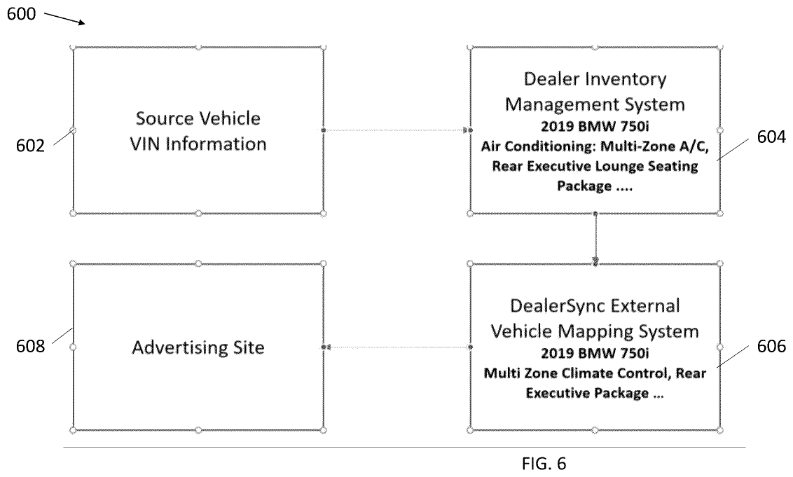

Vehicle data stored in vehicle information repository 208 can then be accessed by or otherwise used by the system, such as by matching the data to an external system 210. In some embodiments, this external system 210 could be a third party mapping software system that is accessible via a computer network (see FIG. 6 and associated description for additional information).

Finally, vehicle data matched to an external system in 210 can be outputted or otherwise used by at least one external data target 212. This could include transmitting to or making the data available to one or more third-parties, providing real-time update for a server, storing for later internal system use, or many others. In some embodiments external data target 212 can be a system of a third-party site and may add internal system XML, or other data from a VIN provider (see FIG. 4 and associated description for additional information).

Data from stored vehicle data source 202 can be used in human data analysis 214. As such, humans are able to tag, edit, modify, interpret, and otherwise work with the data. This can include determining and implementing basic ruleset(s) and exceptions to such ruleset(s) (also known as outliers).

Likewise, data from stored vehicle data source 202 can be used or subjected to static analysis information parsing 216. After static analysis information parsing 216, statistical analysis, grouping, weighting, and normalization operations are conducted in step 218. Here, human reviewed ruleset(s) that are generated from the mapping processes for the purpose of weighting and adjusting ruleset(s) can be used to cover or otherwise interpret ambiguous inputs and outliers.

Results of one or both of human data analysis 214 and statistical analysis, grouping, weighting, and normalization operations from step 218 can function as inputs to generate rule sets 220, resulting in applicable and usable rule sets 222. For example, manual injection by a human for one-off or single instance data can be performed in order to ensure accuracy. Here, a description such as “cool blue seats” may not actually mean ventilated or cooled seats, but might indicate a color package instead.

Rule sets 222 can be sent to and used in a feedback loop with machine learning processes 224. Rule sets 222 can also access from and write data to vehicle information repository 208. As such, rule sets 222 data can be run through machine learning processes that may further refine, develop, create, or modify rule sets 222, which may then be used in further machine learning processes 224 for even more detailed and/or robust results. Rule sets 222 may also use data from vehicle information repository 208 that can then be run through machine learning processes 224, which can be from Google APIs and others.

A variety of machine learning processes can be employed in the systems and methods herein. These can include supervised learning (e.g. for classification and others), which can be used to create one or more ruleset(s), to process vehicle information (e.g. trim, color scheme(s), drivetrain, engine attributes, options, optional packages, specifications, styles, supported fuel types, transmission, and others). In various embodiments, each iteration may generate additional rules for identifying potential matches based on the associated options.

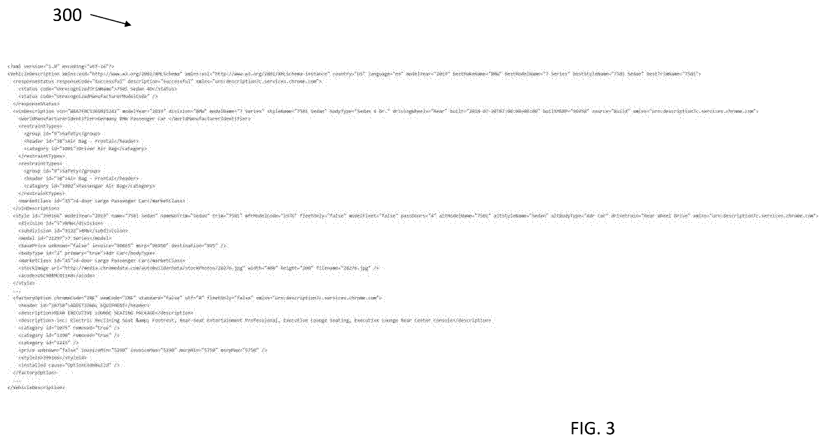

FIG. 3 illustrates code 300 for adding VIN data to a system, according to some embodiments. As shown in the example embodiment, VIN data and associated information about packages, features, and components, as well as images, can be stored in the system.

FIG. 4 illustrates an advertising site wireframe 400, according to some embodiments. As shown in the example embodiment, various information can be included about a vehicle including price, location, color, gas mileage, engine, fuel type, VIN, and others. Options that may require external mapping can be included as a “major options” field, and may include leather seats, driver assistance package, sunroof/moonroof, power mirror package, executive package, navigation system, adaptive cruise control, alloy wheels, premium wheels, blind spot monitoring, heat package, parking sensors, heated seats, luxury package, multi zone climate control, Bluetooth, backup camera, and/or others.

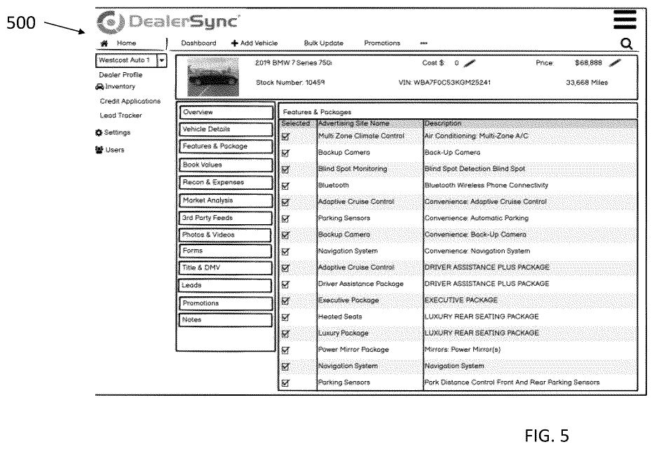

FIG. 5 illustrates data parsed into an inventory matching system wireframe 500, according to some embodiments. As shown in the example embodiment, features on an advertising site may have a particular name while the description may further elaborate on exactly what that name means for a particular vehicle.

FIG. 6 illustrates a flow chart 600; according to some embodiments. As shown in the example embodiment, source vehicle information 602 can be associated with or stored by dealer inventory management system (e.g. that a particular 2019 BMW 750i vehicle information included air conditioning with multi-zone AC and a rear executive lounge seating package) in 604. This information can be run through the external mapping operations disclosed herein in 606 (e.g. that the external system calls the packages simply multi zone climate control and rear executive package). Next, in 608, results can be exported to and/or displayed on an advertising site.

Many different embodiments have been disclosed herein, in connection with the above description and the drawings. It will be understood that it would be unduly repetitious and obfuscating to describe and illustrate every combination and subcombination of these embodiments. Accordingly, all embodiments can be combined in any way and/or combination, and the present specification, including the drawings, shall be construed to constitute a complete written description of all combinations and subcombinations of the embodiments described herein, and of the manner and process of making and using them, and shall support claims to any such combination or subcombination.

An equivalent substitution of two or more elements can be made for any one of the elements in the claims below or that a single element can be substituted for two or more elements in a claim. Although elements can be described above as acting in certain combinations and even initially claimed as such, it is to be expressly understood that one or more elements from a claimed combination can in some cases be excised from the combination and that the claimed combination can be directed to a subcombination or variation of a subcombination.

It will be appreciated by persons skilled in the art that the present embodiment is not limited to what has been particularly shown and described hereinabove. A variety of modifications and variations are possible in light of the above teachings without departing from the following claims.

What is claimed is:

1. A system for external vehicle mapping, comprising:
vehicle data stored in at least one stored vehicle data source;
a processor performing a mapping process on vehicle data;
storing vehicle information in a repository; and
providing data to an external data target.

2. The system of claim 1, wherein the vehicle data is captured by a computing device.

3. The system of claim 1, wherein the processor performs static analysis information parsing and statistical analysis, grouping, weighting, and normalization on the vehicle data to generate at least one rule set.

4. The system of claim 3, wherein the rule set also received human data analysis input via an interface.

5. The system of claim 3, wherein the generated at least one rule set is used in a machine learning process by the processor.

6. The system of claim 3, wherein the generated at least one rule set is operable to exchange data with the repository.

7. The system of claim 1, further comprising:
the mapping processes undergoing at least one natural language processing operation.

8. The system of claim 7, wherein an output of the at least one natural language processing operation is stored in non-transitory computer readable memory in the repository.

9. A computer implemented method for vehicle information analysis and management via a network, comprising computer instructions stored in non-transitory computer readable memory of a server that, when executed by a processor of the server cause the server to perform the steps of:
storing vehicle information associated with one or more vehicles in non-transitory memory in a stored vehicle data source after the image processing operation has been performed; and
performing at least one mapping process on the stored vehicle information,
wherein the vehicle data comprises information about a manufacturer package.
